(19) United States
(12) Patent Application Publication
(10) Pub. No.: US 2017/0130815 A1
(43) Pub. Date: May 11, 2017

(54) COMPACT ELECTRONICALLY CONTROLLED FRONT WHEEL DRIVE TORQUE VECTORING SYSTEM WITH SINGLE OR DUAL AXLE MODULATION

(71) Applicant: Eaton Corporation, Cleveland, OH (US)

(72) Inventors: Hongbin Wang, Novi, MI (US); Sean Brown, Southfield, MI (US); Payam Naghshtabrizi, Royal Oak, MI (US); Richard Kukucka, Ann Arbor, MI (US); Gregory Heatwole, Marshall, MI (US); Andrew Edler, Homer, MI (US)

(21) Appl. No.: 15/415,256

(22) Filed: Jan. 25, 2017

Related U.S. Application Data
(63) Continuation of application No. PCT/US2015/041787, filed on Jul. 23, 2015.
(60) Provisional application No. 62/029,045, filed on Jul. 25, 2014.
(60) Provisional application No. 62/061,318, filed on Oct. 8, 2014.
(60) Provisional application No. 62/040,535, filed on Aug. 22, 2014.
(60) Provisional application No. 62/078,741, filed on Nov. 12, 2014.
(60) Provisional application No. 62/090,081, filed on Dec. 10, 2014.
(60) Provisional application No. 62/040,543, filed on Aug. 22, 2014.
(60) Provisional application No. 62/085,786, filed on Dec. 1, 2014.

(51) Int. Cl. F16H 48/36; F16H 48/22; B60K 23/04; B60K 17/16; F16D 21/00; F16D 28/00; F16D 23/12; B60K 17/30; F16H 48/08; F16D 13/52

(52) U.S. Cl. CPC F16H 48/36; F16H 48/08; F16H 48/22; B60K 23/04; F16D 13/52; F16D 21/00; F16D 28/00; F16D 23/12; B60K 17/30; B60K 17/16; F16H 2048/366; F16H 2048/343

(57) ABSTRACT

A torque vectoring system constructed in accordance to one example of the present disclosure includes a differential, a first drive axle, a second drive axle, a first gear train and a second gear train. The first drive axle is operably coupled to the differential. The second drive axle is operable coupled to the differential. The first gear train is selectively driven by the differential and is configured to selectively supply a speed application from the differential to one of the first and second drive axles. The second gear train is selectively driven by the differential and is configured to selectively supply a speed reduction from the differential to one of the first and second drive axles.

### CROSS-REFERENCE TO RELATED APPLICATIONS

This application is a continuation of International Application No. PCT/US2015/041787 filed on Jul. 23, 2015, which claims the benefit of U.S. Patent Application No. 62/029,045 filed on Jul. 25, 2014, U.S. Patent Application No. 62/061,318 filed on Oct. 8, 2014, U.S. Patent Application No. 62/040,535 filed on Aug. 22, 2014, U.S. Patent Application No. 62/078,741 filed on Nov. 12, 2014, U.S. Patent Application No. 62/090,081 filed on Dec. 10, 2014, U.S. Patent Application No. 62/040,543 filed on Aug. 22, 2014, and U.S. Patent Application No. 62/085,786 filed on Dec. 1, 2014. The disclosures of the above applications are incorporated herein by reference.

### FIELD

The present disclosure relates generally to differential assemblies and, more particularly, to an electronic limited slip differential.

### BACKGROUND

Differentials are provided on vehicles to permit an outer drive wheel to rotate faster than an inner drive wheel during cornering as both drive wheels continue to receive power from the engine. While differentials are useful in cornering, they can allow vehicles to lose traction, for example, in snow or mud or other slick mediums. If either of the drive wheels loses traction, it will spin at a high rate of speed and the other wheel may not spin at all. To overcome this situation, limited-slip differentials were developed to shift power from the drive wheel that has lost traction and is spinning, to the drive wheel that is not spinning. Typically, a clutch pack can be disposed between a side gear of the differential and an adjacent surface of a gear case of the differential. The clutch pack is operable to limit relative rotation between the gear case and the side gear. Further, it is often desirable to apply torque vectoring wherein the power directed to the drive wheels is varied.

The background description provided herein is for the purpose of generally presenting the context of the disclosure. Work of the presently named Inventors, to the extent it is described in this background section, as well as aspects of the description that may not otherwise qualify as prior art at the time of filing, are neither expressly nor impliedly admitted as prior art against the present disclosure.

### SUMMARY

A torque vectoring system constructed in accordance to one example of the present disclosure includes a differential, a first drive axle, a second drive axle, a first gear train and a second gear train. The first drive axle is operably coupled to the differential. The second drive axle is operable coupled to the differential. The first gear train is selectively driven by the differential and is configured to selectively supply a speed application from the differential to one of the first and second drive axles. The second gear train is selectively driven by the differential and is configured to selectively supply a speed reduction from the differential to one of the first and second drive axles.

According to additional features, the torque vectoring system can further include a first clutch and a second clutch. The first clutch can be configured to selectively couple the first gear train to the first axle during a speed up request. The second clutch can be configured to selectively couple the second gear train to the first axle during a speed down request. An actuator can be configured to selectively close one of the first clutch or the second clutch. The actuator can include a lever arm. The actuator can be configured to move a lever arm (i) in a first direction to close the first clutch and (ii) in a second direction to close the second clutch.

According to other features the first clutch includes a first clutch pack positioned in a first clutch basket. The second clutch includes a second clutch pack positioned in a second clutch basket. The actuator can be configured to automatically engage a corresponding gear train path for modulating the first and second drive axles based on a request of vehicle drive conditions. In one configuration the actuator comprises a ball screw assembly including a motor that isolates a shaft in one of a first and second direction. A first thrust plate can be configured to transmit force from the lever arm onto the first clutch pack. A second thrust plate can be configured to transmit force from the lever arm onto the second clutch pack. The lever arm can be positioned between the first and second clutch packs such that the lever arm is precluded from moving concurrently in the first and second directions.

According to still other features, the torque vectoring system can further comprise a countershaft drive gear set and a driven gear set. The countershaft drive gear set can have a countershaft gear meshed with a countershaft mating gear. The driven gear set can have a first driven gear and a second driven gear. The countershaft mating gear and the first driven gear are mounted for concurrent rotation with a gear shaft. The second driven gear is fixed for concurrent rotation with the other of the first and second drive axles.

According to additional features, the torque vectoring system can include an electromechanical clutch having a clutch pack, a thrust plate and a ball screw assembly. The clutch pack has first and second sets of clutch plates. The thrust plate is moveably positioned proximate to the clutch pack. The ball screw assembly is engaged with the thrust plate. The ball screw is operable to move the thrust plate to press the first and second sets of clutch plates together and thereby lock the clutch. The thrust plate is pivotably moveable. A thrust bearing is positioned between the thrust plate and the first and second sets of clutch plates. The torsional spring is engaged with a shaft of the ball screw assembly and is operable to store energy when the shaft is being rotated by a motor of the ball screw assembly.

The torque vectoring system can further include a lever mechanism positioned between the ball screw assembly and the thrust plate. The ball screw assembly defines a modular packaging layout and accommodates add-on design features. A controller is operable to control the motor, the controller storing in memory and operable to execute an actuator control algorithm reducing the likelihood of mechanical backlash and friction hysteresis.

### BRIEF DESCRIPTION OF THE DRAWINGS

The present disclosure will become more fully understood from the detailed description and the accompanying drawings, wherein:

FIGS. 1-5 illustrate an electronically controlled torque vectoring system configured for single axle modulation according to one example of the present disclosure;

FIG. 1 is a schematic of an electronically controlled torque vectoring system constructed in accordance to one example of the present disclosure and configured for single axle modulation;

FIG. 2A is a schematic of driven wheels during a right turn when the electronically controlled torque vectoring system is adding (i) understeer with a first clutch closed and (ii) positive torque with a speed up gear train;

FIG. 2B is a schematic representation of the driven wheels of FIG. 2A;

FIG. 3A is a schematic of driven wheels during a left turn when the electronically controlled torque vectoring system is adding (i) oversteer with a second clutch closed and (ii) negative torque with a speed down gear train;

FIG. 3B is a schematic representation of the driven wheels of FIG. 3A;

FIG. 4A is a schematic of driven wheels illustrating power flow for eLSD of the electronically controlled torque vectoring system;

FIG. 4B is a schematic representation of the driven wheels of FIG. 4A;

FIG. 5 is a schematic of a torque modulation system constructed in accordance to another example of the present disclosure and having a dual clutch upstream of a gear train for smaller clutch pack and actuation force;

FIGS. 6A-8B illustrate an electronically controlled torque vectoring system configured for dual axle modulation according to one example of the present disclosure;

FIG. 6A is a schematic of an electronically controlled torque vectoring system constructed in accordance to one example of the present disclosure and shown with a primary flow path and configured for dual axle modulation;

FIG. 6B is a schematic representation of the driven wheels of FIG. 6A;

FIG. 7A is a schematic of driven wheels during a left turn when the electronically controlled torque vectoring system uses a first speed application geartrain path to add torque to the outer driven wheel;

FIG. 7B is a schematic representation of the driven wheels of FIG. 7A;

FIG. 8A is a schematic of driven wheels during a right turn when the electronically controlled torque vectoring system uses a second speed reduction geartrain path to add torque to the outer driven wheel;

FIG. 8B is a schematic representation of the driven wheels of FIG. 8A;

FIG. 9 is a cross-sectional view of a differential assembly constructed in accordance to another example of the present disclosure;

FIG. 10 is a view taken along perspective arrows 10-10 in FIG. 9; and

FIG. 11 is an exploded view of an electromechanical clutch configured according to another example of the present disclosure.

### DETAILED DESCRIPTION

An electronically controlled torque vectoring system constructed in accordance to one example of the present disclosure is shown and generally identified at reference numeral 10. The electronically controlled torque vectoring system 10 can provide a full range of active torque management functions. The electronically controlled torque vectoring system 10 can provide a seamless transition between an electronically-controlled limited-slip mode (eLSD), and a torque vectoring mode. Examples of the electronically controlled torque vectoring system 10 can include a bolt-on modular design, with minimum impact to original equipment manufacturers. The torque vectoring system 10 can be packaged into the power take off (PTO) space for an all-wheel drive vehicle.

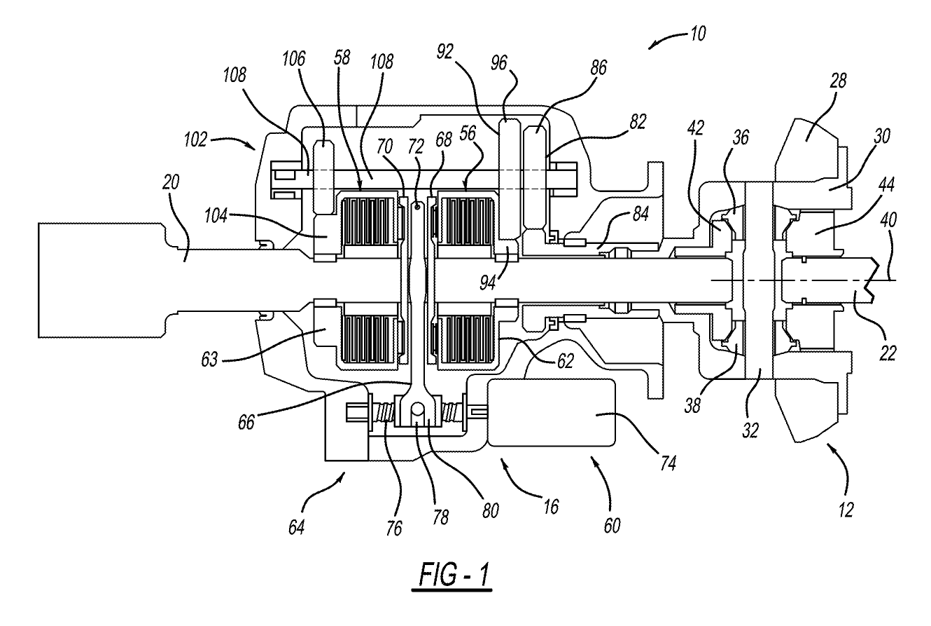

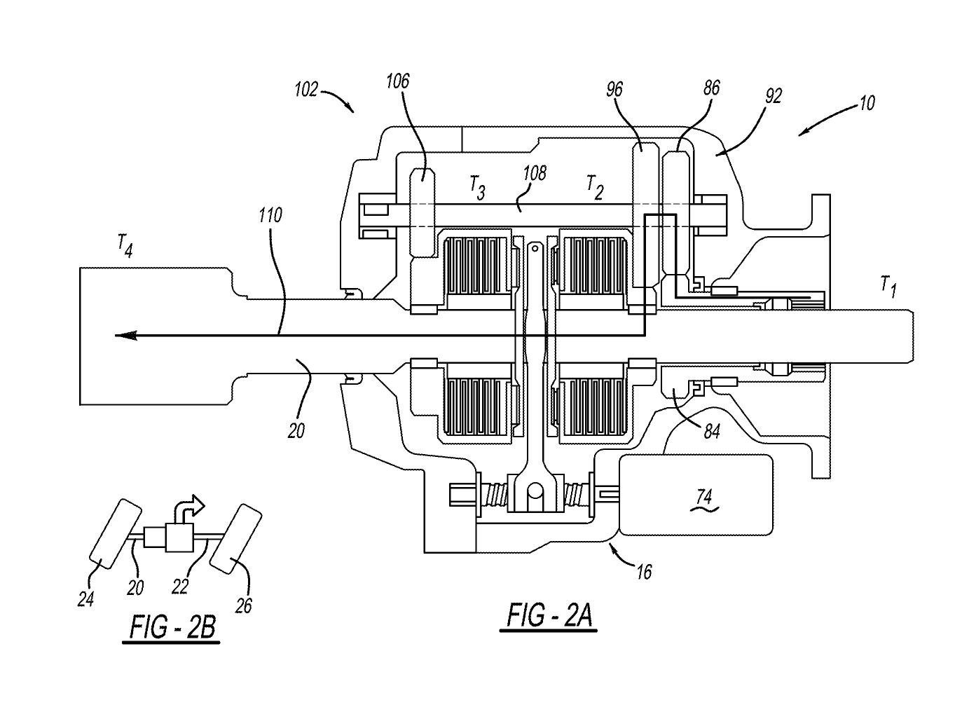

Referring now to FIG. 1, the electronically controlled torque vectoring system 10 can include a differential 12 and a dual-directional electromechanical clutch 16. The electronically controlled torque vectoring system 10 can transmit rotary power to axles 20 and 22. As shown in FIG. 2, the axles 20, 22 can drive wheels 24, 26. As will become appreciated from the following discussion, the electronically controlled torque vectoring system 10 can provide a torque vectoring system with single axle modulation.

The differential 12 can include a ring gear 28, a case 30, a pin 32, and a plurality of pinion gears such as pinion gears 36, 38. The ring gear 28 can be driven in rotation about an axis 40 by a vehicle power source, such as by an engine and a drive shaft (not shown). The ring gear 28 and the case 30 can be fixed for rotation together. The pin 32 can be mounted in the case 30 and rotates with the case 30 and the ring gear 28 about the axis 40. The pinion gears 36, 38 can be respectively mounted on the pin 32 for rotation about the respective pins 32. The pinion gears 36, 38 can mesh with side gears 42 and 44. The side gear 42 can be fixed for rotation with the axle 20 and the side gear 44 can be fixed for rotation with the axle 22.

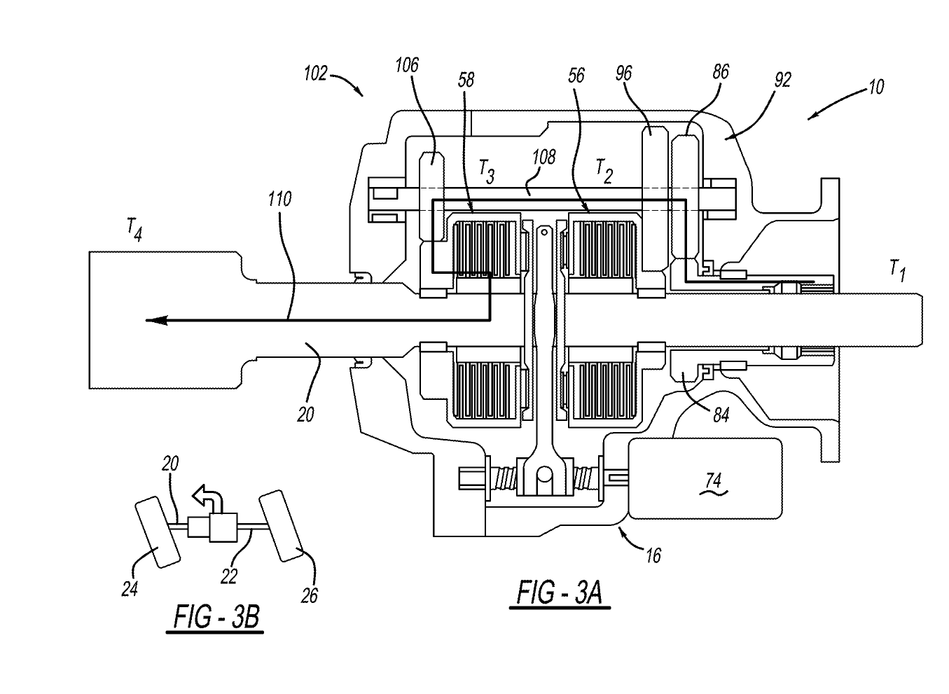

The dual-directional clutch 16 can include a first clutch pack 56, a second clutch pack 58, and an actuator 60. The first clutch pack 56 can be positioned in a first clutch basket 62. The second clutch pack 58 can be positioned in a second clutch basket 63. The actuator 60 can be a single actuator configured to automatically engage a corresponding gear train path (FIG. 2 or 3) for modulating the drive axles based on a request of vehicle drive conditions. As used herein the term “modulate” is used to refer to moving either clutch pack 56, 58 to a fully locked state, a fully open state, one or more operating states between fully locked and fully open.

The actuator 60 can include a ball screw assembly 64, a lever arm 66, a first thrust plate 68, and a second thrust plate 70. The ball screw assembly 64 can be operable to pivot the lever arm 66 about a pivot axis 72 in first and second opposite angular directions. The ball screw assembly 64 can include a motor 74, a shaft 76, and a nut 78. The motor 74 can rotate the shaft 76 in first and second opposite directions of rotation. The motor 74 can include an internal speed reduction gear set and one or more speed sensors, current sensors or both. The nut 78 can move in a first rectilinear direction in response to rotation of the shaft 76 in the first rotational direction. The nut 78 can move in a second rectilinear direction, opposite to the first rectilinear direction, in response to rotation of the shaft 76 in the second rotational direction. A distal end 80 of the lever arm 66 can form a yoke partially encircling one of the shaft 76 the nut 78.

In operation, the motor 74 can rotate the shaft 76 in the first rotational direction. In response, the nut 78 can move in the rectilinear direction referenced at 82. It is noted that the distance travelled by the nut 78 can be small. The distal end 80 of the lever arm 66 can thereby be urged to pivot about the pivot axis 72, causing the application of force to the first thrust plate 68. Further, the force can be transmitted by the first thrust plate 68 to the clutch pack 56, (incrementally) closing the clutch pack 56.

In operation, the motor 74 can also rotate the shaft 76 in the second rotational direction. In response, the nut 78 can move in the rectilinear direction referenced at 84. It is noted that the distance travelled by the nut 78 can be small. The distal end 80 of the lever arm 66 can thereby be urged to pivot about the pivot axis 72, causing the application of force to the second thrust plate 70. Further, the force can be transmitted by the second thrust plate 70 to the clutch pack 58, (incrementally) closing the clutch pack 58.

It is noted that other forms of actuators that provide bi-directional actuation can be applied in other examples of the present disclosure. It is also noted that linear actuators other than rotation motors and force multiplication mechanisms other than ball screw assemblies can be included in other examples of the present disclosure. For example, one or more fluid cylinders could be applied to move the distal end 80 of the lever arm 66.

The electronically controlled torque vectoring system 10 can further include a countershaft drive gear set, collectively referenced at 82, and including a countershaft gear 84 meshed with a countershaft mating gear 86. The countershaft gear 84 can be fixed for rotation with the differential case 30. A first gear train or speed up gear train, collectively referenced at 92, can include a first basket gear 94 meshed with a first drive gear 96. A second gear train or speed down gear train, collectively referenced at 102, can include a second basket gear 104 meshed with a second drive gear 106. The countershaft mating gear 86, the first drive gear 96 and the second drive gear 106 can all be fixed for concurrent rotation with a gear shaft 108.

FIGS. 2 and 3 shows the electronically controlled torque vectoring system 10 operating in a torque vectoring, right-turn mode (FIG. 2) and a torque vectoring left-turn mode (FIG. 3). In a torque vectoring mode, the electronically controlled torque vectoring system 10 can (i) close the first clutch pack 56 creating positive torque with the speed up gear train 92 (FIG. 2), or (ii) close the second clutch pack 58 creating negative torque with the speed down gear train 102 (FIG. 3). Notably, with the current configuration, the actuator 60 and ball screw assembly 64 can only close (or partially close) one of the clutch packs 56, 58. With reference to FIG. 2, a torque path 110 can be created from the countershaft gear 84, to the countershaft mating gear 86, through the first drive gear 96, first basket gear 94 (the first clutch basket 62), the first clutch pack 56 and the axle shaft 20. In the example shown, the speed up gear train provides a gear ratio of 1.1. Explained further, for every one rotation of the countershaft gear 84, the axle shaft 20 will rotate 1.1 times. Other ratios are contemplated. With reference to FIG. 3, a torque path 120 can be created from the countershaft gear 84, to the countershaft mating gear 86, along the gear shaft 108, through the second drive gear 106, second basket gear 104 (the second clutch basket 63), the second clutch pack 58 and the axle shaft 20. In the example shown, the speed down gear train provides a gear ratio of 0.9. Explained further, for every one rotation of the countershaft gear 84, the axle shaft 20 will rotate 0.9 times. Other ratios are contemplated. For torque vectoring function, based on driving condition, the dual-directional clutch 16 automatically engages either the first clutch pack 56 or the second clutch pack 58 for speeding up the outer wheel or speeding down the inner wheel. For eLSD operation, either the first clutch pack 56 or the second clutch pack 58 can be modulated to provide braking to the identified wheel.

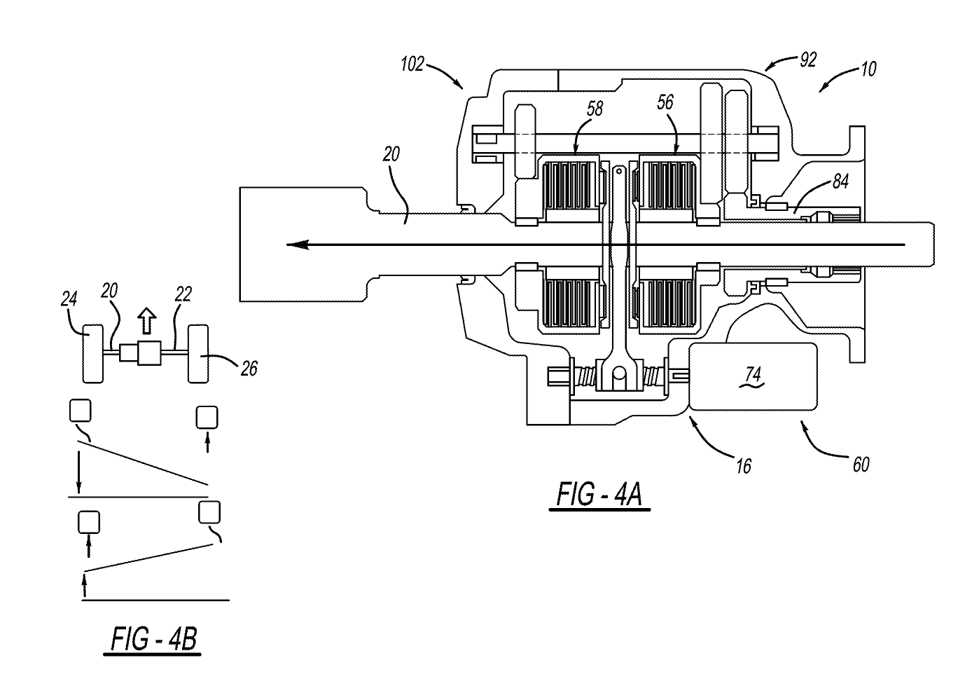

FIG. 4 illustrates a schematic of driven wheels illustrating power flow for eLSD of the electronically controlled torque vectoring system 10. Even at a locked up condition (left and right driven wheels rotating at the same speed), the dual-directional clutch 16 is still slipping due to gear ratio. During operation, when the left wheel is slipping, the first clutch 56 (FIG. 1) can be engaged to utilize the speed down path clutch. When the right wheel is slipping, the second clutch 58 (FIG. 1) can be engaged to utilize the speed up path clutch.

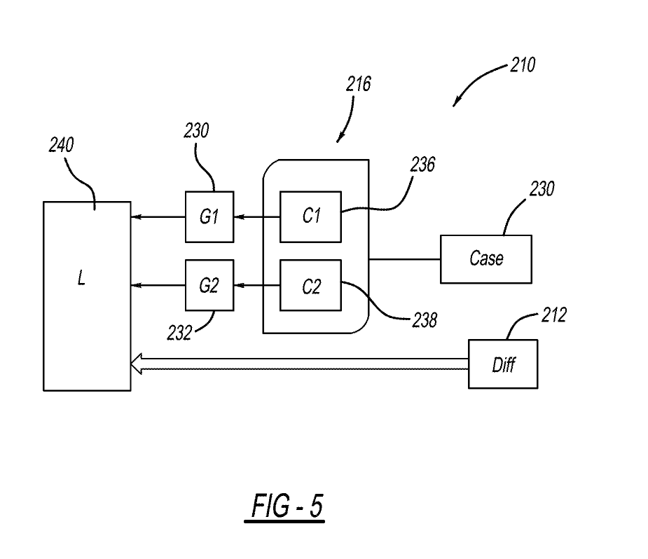

FIG. 5 is a schematic of a torque modulation system 210 constructed in accordance to another example of the present disclosure and having a dual clutch 216 upstream of a first gear train 230 and a second gear train 232. The dual clutch 216 can include a first clutch 236 and a second clutch 238. In one arrangement, the differential 212 can be configured to drive a load 240. A differential case 230 can be configured to drive the load 240 through the dual clutch 216 and the first and second gear trains 230 and 232. The torque modulation system 210 can be used for smaller clutch pack and actuation force configurations.

An electronically controlled torque vectoring system constructed in accordance to another example of the present disclosure is shown and generally identified at reference numeral 310. The electronically controlled torque vectoring system 310 can provide a full range of active torque management functions. The electronically controlled torque vectoring system 310 can provide a seamless transition between an electronically-controlled limited-slip mode (eLSD), and a torque vectoring mode. Examples of the electronically controlled torque vectoring system 310 can include a bolt-on modular design, with minimum impact to original equipment manufacturers. In one configuration the torque vectoring system 310 can be configured as a front wheel drive application. In other examples, the torque vectoring system 310 can be packaged into the power take off (PTO) space for an all-wheel drive vehicle.

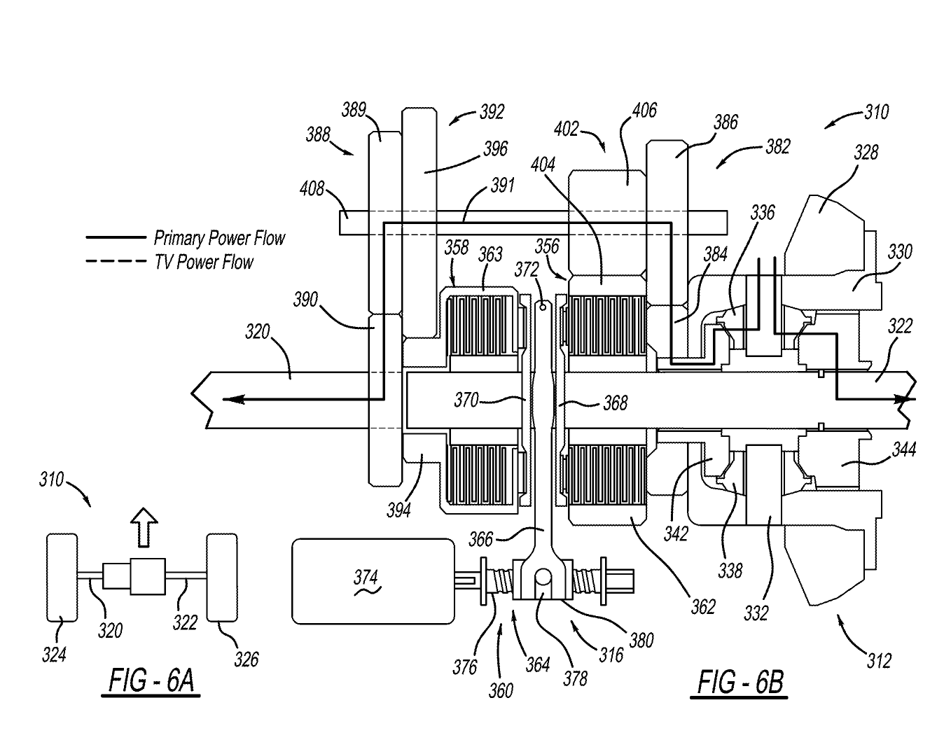

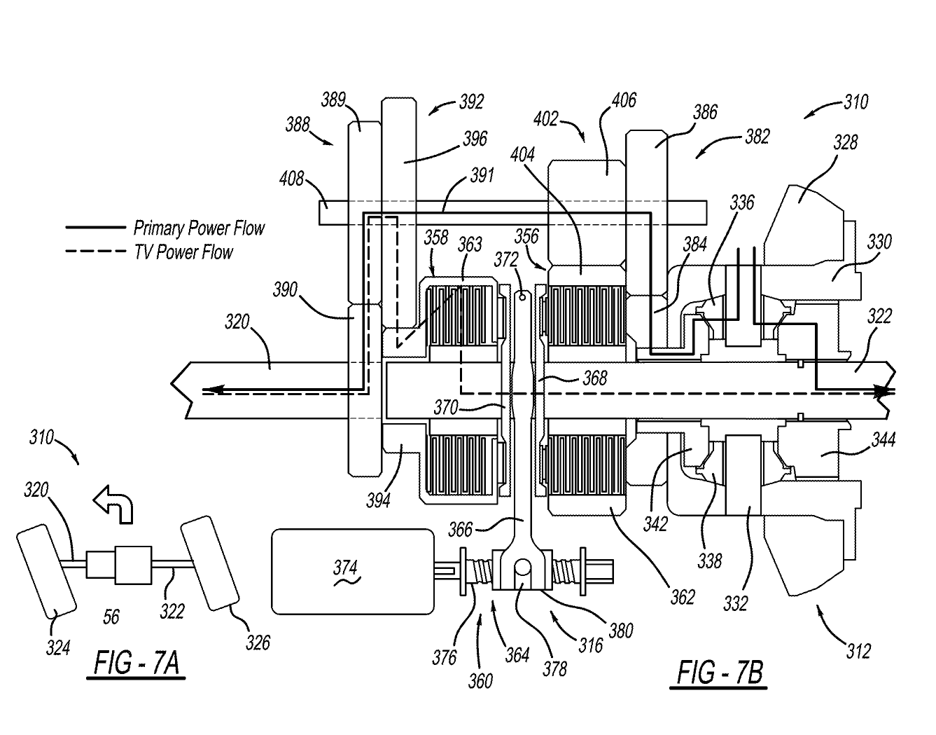

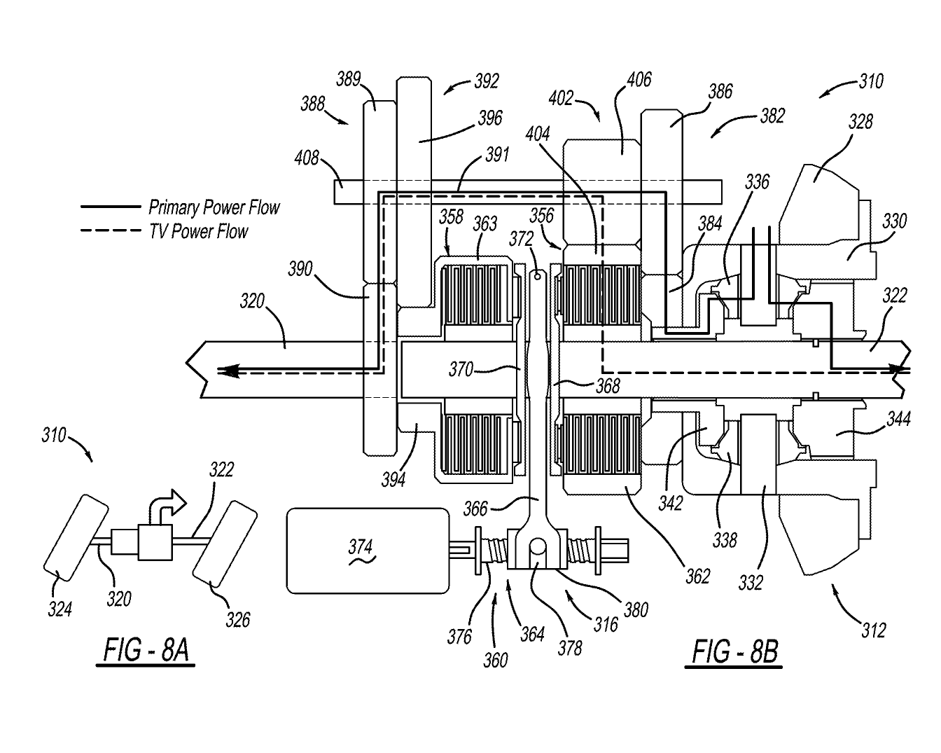

Referring now to FIGS. 6A and 6B, the electronically controlled torque vectoring system 310 can include a differential 312 and a dual-directional electromechanical clutch 316. The electronically controlled torque vectoring system 310 can transmit rotary power to axles 320 and 322. As shown in FIGS. 6A and 6B, the axles 320, 322 can drive wheels 324, 326. As will become appreciated from the following discussion, the electronically controlled torque vectoring system 310 can provide a torque vectoring system with dual axle modulation.

The differential 312 can include a ring gear 328, a case 330, a pin 332, and a plurality of pinion gears such as pinion gears 336, 338. The ring gear 328 can be driven in rotation about an axis 340 by a vehicle power source, such as by an engine and a drive shaft (not shown). The ring gear 328 and the case 330 can be fixed for rotation together. The pin 332 can be mounted in the case 330 and rotates with the case 330 and the ring gear 328 about the axis 340. The pinion gears 336, 338 can be respectively mounted on the pin 332 for rotation about the respective pins 332. The pinion gears 336, 338 can mesh with side gears 342 and 344. The side gear 342 can be fixed for rotation with the axle 320 and the side gear 344 can be fixed for rotation with the axle 322.

The dual-directional clutch 316 can include a first clutch pack 356, a second clutch pack 358, and an actuator 360. The first clutch pack 356 can be positioned in a first clutch basket 362. The second clutch pack 358 can be positioned in a second clutch basket 363. The actuator 360 can be a single actuator configured to automatically engage a corresponding gear train path (FIGS. 7A or 7B) for modulating the drive axles 320, 322 based on a request of vehicle drive conditions. As used herein the term “modulate” is used to refer to moving either clutch pack 356, 358 to a fully locked state, a fully open state, one or more operating states between fully locked and fully open.

The actuator 360 can include a ball screw assembly 364, a lever arm 366, a first thrust plate 368, and a second thrust plate 370. The ball screw assembly 364 can be operable to pivot the lever arm 366 about a pivot axis 372 in first and second opposite angular directions. The ball screw assembly 364 can include a motor 374, a shaft 376, and a nut 378. The motor 374 can rotate the shaft 376 in first and second opposite directions of rotation. The motor 374 can include an internal speed reduction gear set and one or more speed sensors, current sensors or both. The nut 378 can move in a first rectilinear direction in response to rotation of the shaft 376 in the first rotational direction. The nut 378 can move in a second rectilinear direction, opposite to the first rectilinear direction, in response to rotation of the shaft 376 in the second rotational direction. A distal end 380 of the lever arm 366 can form a yoke partially encircling one of the shaft 376 the nut 378.

In operation, the motor 374 can rotate the shaft 376 in the first rotational direction. In response, the nut 378 can move in a rectilinear direction. It is noted that the distance travelled by the nut 378 can be small. The distal end 380 of the lever arm 366 can thereby be urged to pivot about the pivot axis 372, causing the application of force to the first thrust plate 368. Further, the force can be transmitted by the first thrust plate 368 to the clutch pack 356, (incrementally) closing the clutch pack 356.

In operation, the motor 374 can also rotate the shaft 376 in the second rotational direction. In response, the nut 378 can move in a rectilinear direction. It is noted that the distance travelled by the nut 378 can be small. The distal end 380 of the lever arm 366 can thereby be urged to pivot about the pivot axis 372, causing the application of force to the second thrust plate 370. Further, the force can be transmitted by the second thrust plate 370 to the clutch pack 358, (incrementally) closing the clutch pack 358.

It is noted that other forms of actuators that provide bi-directional actuation can be applied in other examples of the present disclosure. It is also noted that linear actuators other than rotation motors and force multiplication mechanisms other than ball screw assemblies can be included in other examples of the present disclosure. For example, one or more fluid cylinders could be applied to move the distal end 80 of the lever arm 66.

The electronically controlled torque vectoring system 310 can further include a countershaft drive gear set, collectively referenced at 382, and including a countershaft gear 384 meshed with a countershaft mating gear 386. The countershaft gear 384 can be fixed for rotation with the differential case 330. The torque vectoring system 310 can additionally include a driven gear set, collectively referenced at 388, and including a first driven gear 389 and a second driven gear 390. The second driven gear 390 can be fixed for rotation with the drive axle 320.

With particular reference to FIG. 6B, a primary power flow path 391 will be described. The primary power flow path 391 can be used during normal driving conditions. The primary power flow path 391 is followed when the differential 312 operates as an open differential where power is delivered in various proportions to the first and second axle shafts 320 and 322 based on operating conditions (and no modulation from the dual-directional clutch 316). Torque from the differential case 330 is communicated (i) from the side gear 342, through the countershaft gear set 382, along a gear shaft 408, through the driven gear set 388 and to the axle shaft 320 and (ii) from the side gear 344 to the axle shaft 322.

A first gear train or speed up gear train, collectively referenced at 392, can include a first basket gear 394 meshed with a first drive gear 396. A second gear train or speed down gear train, collectively referenced at 402, can include a second basket gear 404 meshed with a second drive gear 406. The countershaft mating gear 386, the first drive gear 396 and the second drive gear 406 can all be fixed for concurrent rotation with the gear shaft 408.

FIG. 7A shows the electronically controlled torque vectoring system 310 operating in a torque vectoring, left-turn mode. In this mode, the electronically controlled torque vectoring system 310 can close the second clutch pack 358 creating positive torque with the speed up gear train 392. In FIG. 8A, the electronically controlled torque vectoring system 310 is shown operating in a torque vectoring, right-turn mode. In this mode, the electronically controlled torque vectoring system 310 can close the first clutch pack 356 creating negative torque with the speed down gear train 402.

Notably, with the current configuration, the actuator 360 and ball screw assembly 364 can only close (or partially close) one of the clutch packs 356, 358. With reference to FIG. 7A, a torque vectoring torque path 410 can be created from the countershaft gear 384, to the countershaft mating gear 386, along the gear shaft 408, through the first drive gear 396, first basket gear 394 (the second clutch basket 363), the second clutch pack 358 and the second axle shaft 322. In the example shown, the speed up gear train 392 provides a gear ratio of 1.1. Explained further, for every one rotation of the countershaft gear 384, the second axle shaft 322 will rotate 1.1 times. Other ratios are contemplated.

With reference to FIG. 8A, a torque vectoring torque path 420 can be created from the countershaft gear 384, to the countershaft mating gear 386, along the gear shaft 408, through the second drive gear 406, second basket gear 404 (the first clutch basket 362), the first clutch pack 356 and the second axle shaft 322. In the example shown, the speed down gear train 402 provides a gear ratio of 0.9. Explained further, for every one rotation of the countershaft gear 384, the second axle shaft 322 will rotate 0.9 times. Other ratios are contemplated. For torque vectoring function, based on driving conditions, the dual-directional clutch 316 automatically engages either the first clutch pack 356 or the second clutch pack 358 for speeding up or speeding down the second axle 322. For eLSD operation, either the first clutch pack 356 or the second clutch pack 358 can be modulated to provide braking to the identified wheel.

During operation, when the left wheel is slipping, the second clutch 358 can be engaged (FIG. 7A) to utilize the speed application path clutch (transferring more torque to the right wheel). Explained further, the torque vectoring torque path 410 (speed application) can be used by communicating torque from the first drive gear 396, through the clutch basket 363 and to the drive axle 322. When the right wheel is slipping, the first clutch 356 can be engaged (FIG. 8A) to utilize the speed reduction path clutch (transferring more torque to the left wheel). Explained further, the torque vectoring torque path 420 (speed reduction) can be used by communicating torque from the second drive gear 406, through the clutch basket 362 and to the drive axle 322. In this regard, the first clutch 356 and the second clutch 358 are used to provide proper amount of slip for the control of speed and torque request to the dual axles 320, 322. The co-axial design of the electronically controlled torque vectoring system 310 provides a compact radial dimension suitable for receipt in tight packaging situations.

The present teachings generally include an electromechanical clutch actuation system that can be shown to provide high mechanical advantage, relatively compact packaging, better controllability, and combinations thereof. The actuation system can include an electric motor and a speed reduction gear set. The actuation system can include one or more motor speed sensors or one or more current sensors or both. The actuation system can further include a ball screw interacting with a nut for transferring rotational motion to linear motion during operation. The actuation system can also include a level arm and linkage to apply an axial force to a differential clutch pack. The level arm and linkage can be shown to provide a relatively high mechanical advantage mechanism that can be robust to variations due to temperature and wear from usage.

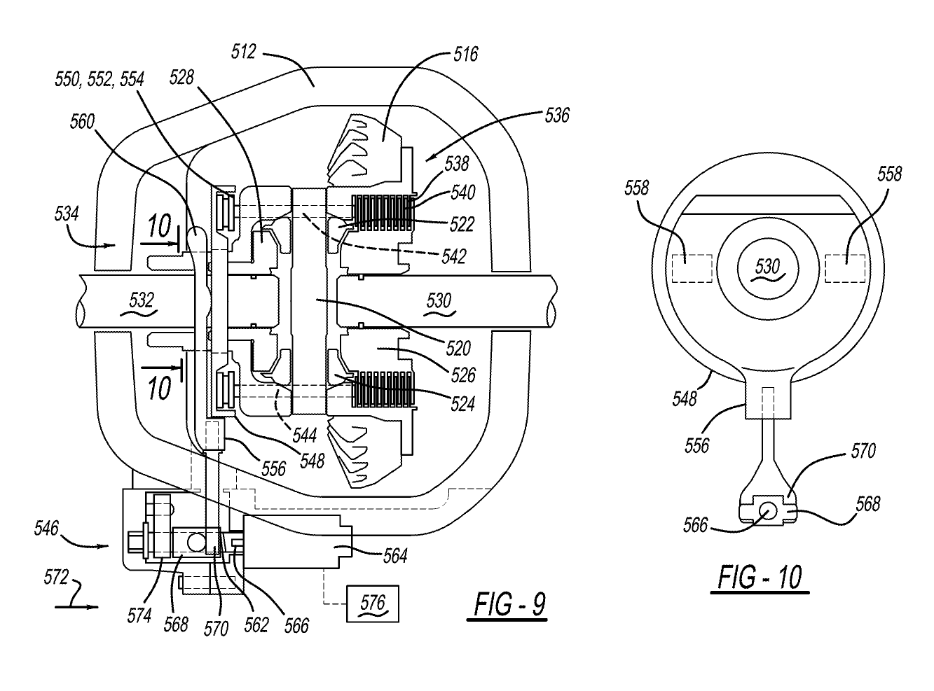

FIGS. 9 and 10 are views of a differential assembly 510 constructed in accordance to another example of the present disclosure. The differential assembly 510 can include a case 512 and a cover 514. A ring gear 516 can be positioned in the case 512. The ring gear 516 can be driven in rotation by a drive shaft (not shown) driven in rotation by an engine. The ring gear 516 can be fixed for rotation with a housing 518. A plurality of pins, such as pin 520, can be mounted in the housing 518. One or more pinion gears, such as pinion gears 522, 524, can be mounted on each of the pins for rotation relative to the respective pin. Each pinion gear can be meshed with side gears 526, 528. Axle shafts 530, 532 can be fixed for rotation with the side gears 526, 528.

The differential assembly 510 can include an electronic limited slip assembly having an electromechanical clutch 534, as shown in FIG. 9. The clutch 534 can be operably disposed between the housing 518 and the side gear 526 to selectively lock the housing 518 and the side gear 526. The clutch 534 can be selectively engaged to limit slip of the associated axle 530 relative to the housing 518 and thus relative to the rotational input to the differential assembly 510.

The clutch 534 can include a clutch pack 536. The clutch pack 536 can include a first set of clutch plates, such as clutch plate 538, fixed for rotation with the housing 518. The clutch pack 536 can also include a second set of clutch plates, such as clutch plate 540, fixed for rotation with the side gear 526. The clutch 534 can also include one or more pins, such as pins 542 and 544, passing through the housing 518. The pins 542, 544 can transmit forces to compress the first and second sets of clutch plates 538, 540 against one another, locking the housing 518 and the side gear 526 together.

The clutch 534 can also include an actuation arrangement 546 to transmit force against the pins 542, 544. The actuation arrangement 546 can include a thrust plate 548. A thrust bearing 550 with races 552, 554 can be disposed between the thrust plate 548 and the pins 542, 544. It is noted that other examples of the present disclosure can be arranged such that a thrust bearing is disposed between the thrust plate and the clutch plates, omitting the pins.

The actuation arrangement 546 can also include a lever mechanism having a lever arm 556 operable to urge the thrust plate 548 against the pins 542, 544. The lever arm 556 can include contact pad portions 558 contacting the thrust plate 548. The lever arm 556 can be mounted in the case 512 for pivoting movement about a pivot axis 560.

The actuation arrangement 546 can also include a ball screw assembly 562 operable to pivot the lever arm 556 about the pivot axis 560 to urge the thrust plate 548 against the pins 542, 544 and thereby engage the clutch 534. The ball screw assembly 562 can include a motor 564, a shaft 566, and a nut 568. The motor 564 can rotate the shaft 566 in a first and second opposite directions of rotation. The motor 564 can include an internal speed reduction gear set and one or more speed sensors, current sensors or both. The nut 568 can move in a first rectilinear direction in response to rotation of the shaft 566 in the first rotational direction. The nut 568 can move in a second rectilinear direction, opposite to the first rectilinear direction, in response to rotation of the shaft 566 in the second rotational direction. A distal end 570 of the lever arm 556 can form a yoke partially encircling the shaft 566 and abutting the nut 568.

In operation, the motor 564 can rotate the shaft 566 in the first rotational direction. In response, the nut 568 can move in the rectilinear direction referenced at 572. It is noted that the distance travelled by the nut 568 can be small. The distal end 570 of the lever arm 556 can thereby be urged to pivot about the pivot axis 560, causing the application of force to thrust plate 518 through the contact pad portions 558. Further, the force can be transmitted by the thrust plate 518 to the pins 542, 544 and cause the first and second set of clutch plates 538, 540 to be pressed together, locking the clutch 534.

The differential assembly 510 can include a controller 576 operable to control the motor 564. The controller 576 can store in memory and execute an actuator control algorithm to reduce the likelihood of mechanical backlash and friction hysteresis. The controller 576 can communicate with position and current feedbacks, such as position and current sensors disposed within the motor 564 or positioned external of the motor 564.

A torsional spring 574 can be engaged to the shaft 566. When the motor 564 is rotating the shaft in the first rotational direction, the torsional spring 574 can be wound and store energy. When the motor 564 is disengaged, the torsional spring 574 can unwind and release energy, urging the shaft 566 in rotation in the second rotational direction, causing the nut 568 to move in a direction opposite to the direction 572. This movement can unlock the clutch 534.

The illustrated example demonstrates a modular packaging/layout and accommodates add-on design features for a torque management unit for the differential assembly 10. It will be appreciated that features described in FIGS. 9 and 10 may be incorporated into the examples described in FIGS. 1-8B. Likewise, features described in the examples of FIGS. 1-8B may be incorporated into FIGS. 9 and 10. The ball screw assembly 562 can be positioned at any one of numerous different positions relative to the case 512. Further, additional structures that provide other functions can be mounted to or with the ball screw assembly 562. It is also noted that linear actuators other than rotation motors and force multiplication mechanisms other than ball screw assemblies can be included in other examples of the present disclosure. For example, a fluid cylinder could be applied to move the distal end 570 of the lever arm 556.

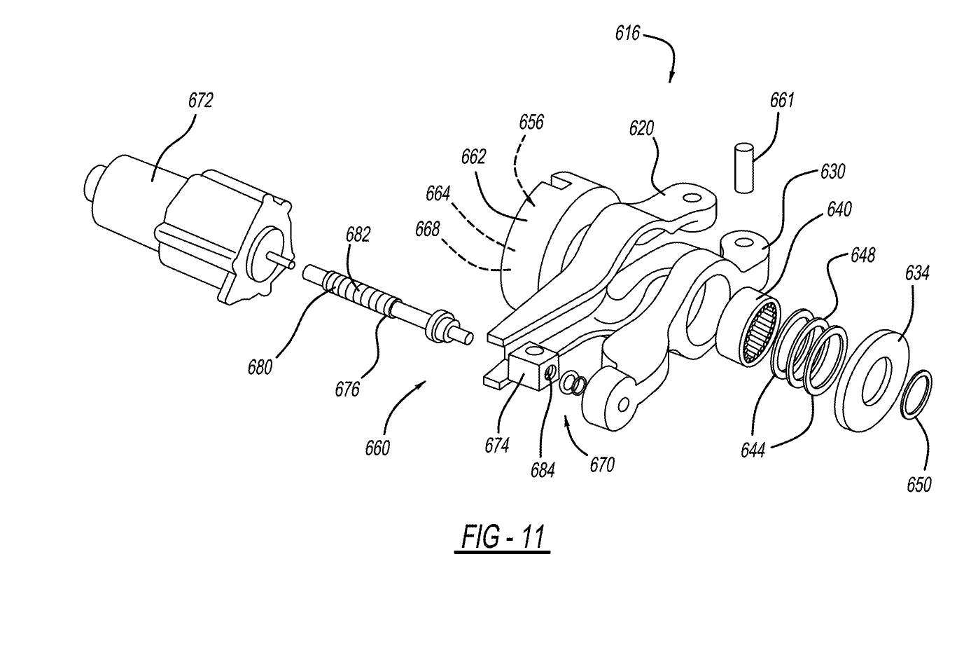

With reference now to FIG. 11, an electromechanical clutch for an electronic limited slip differential according to another example of the present disclosure is shown and generally identified at reference numeral 616. The electromechanical clutch 616 can be configured for operation with a differential such as the differentials 12, 212, 312, and 512 described herein. The electromechanical clutch 616 can include a first lever arm 620, a second lever arm 630, a retaining collar 634, a needle roller bearing 640, a pair of bearing races 644, a needle roller thrust bearing 648, a snap ring 650, a clutch pack 656 and an actuator assembly 660. The first and second lever arms 620, 630 can be pivotally coupled at a pivot pin 661.

The clutch pack 656 can be positioned in a clutch basket 662. The clutch pack can include first and second sets of clutch plates 664, 668. The actuator assembly 660 can be configured to rotatably pivot the first lever arm 620 relative to the second lever arm 630 about the pivot pin 661. The first lever arm 620 is configured to urge the first and second sets of clutch plates 664, 668 together to thereby lock the electromechanical clutch 616. Movement of the first lever arm 620 away from the second lever arm 630 selectively engages the clutch pack 656 to modulate the drive axles (see drive axles 20, 22, FIG. 2B) based on driving conditions.

The actuator assembly 660 can include a ball screw assembly 670 that is operable to pivot the first lever arm 620 relative to the second lever arm 630. The actuator assembly 660 can move the first and second lever arms 620, 630 relative to each other to modulate the clutch pack 656 between a fully locked state, a fully open state and operating states between the fully locked state and the fully open state. In the particular example shown, the first lever arm 620 pivots away from the second lever arm 630 during clutch engagement to modulate the clutch pack 656 toward the fully locked state. Similarly, the first lever arm 620 pivots toward the second lever arm 630 during clutch disengagement.

The ball screw assembly 670 includes a motor 672, a nut 674 and a shaft 676. The motor 672 is configured to rotate the shaft 676. The shaft 676 includes a worm screw or gear 680 having threads 682 that threadably mate with complementary threads 684 defined in the nut 674. Rotation of the worm screw 680 causes the nut 674 to move along an axis of the worm screw 680 resulting in the pivoting of the first lever arm 620 relative to the second lever arm 630.

The retaining collar 634 is coupled to the differential case (see for example case 330, FIG. 7B). The second lever arm 630 is configured to act against the retaining collar 634 during actuation of the electromechanical clutch 616. The configuration limits axial housing stress from the differential. Explained further, the actuation force is reacted against the retaining ring 634 and the clutch pack 656. The actuation force would not get translated through the differential to the axle. Instead, the actuation force is self-contained within the clutch assembly 616. The scissor configuration of the first and second lever arms 620, 630 eliminates a reaction force against the axial housing. As the differential is rotating, the thrust bearing 640 allows the differential to rotate but also allows the clutch actuation force to react axially against the retaining ring 634.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A torque vectoring system comprising:
a differential;
a first drive axle operably coupled to the differential;
a second drive axle operably coupled to the differential;
a first gear train selectively driven by the differential and configured to selectively supply a speed application from the differential to one of the first and second drive axles; and
a second gear train selectively driven by the differential and configured to selectively supply a speed reduction from the differential to one of the first and second drive axles.

2. The torque vectoring system of claim 1 further comprising:
a first clutch configured to selectively couple the first gear train to the first axle during a speed up request; and
a second clutch configured to selectively couple the second gear train to the first axle during a speed down request.

3. The torque vectoring system of claim 2 further comprising:
an actuator configured to selectively close one of the first clutch or the second clutch.

4. The torque vectoring system of claim 3 wherein the actuator further comprises:
a lever arm and wherein the actuator is configured to move the lever arm (i) in a first direction to close the first clutch and (ii) in a second direction to close the second clutch.

5. The torque vectoring system of claim 4 wherein the first clutch includes a first clutch pack positioned in a first clutch basket and wherein the second clutch includes a second clutch pack positioned in a second clutch basket.

6. The torque vectoring system of claim 5 wherein the actuator is configured to automatically engage a corresponding gear train path for modulating the first and second drive axles based on a request of vehicle drive conditions.

7. The torque vectoring system of claim 6 wherein the actuator comprises a ball screw assembly including a motor that isolates a shaft in one of a first and second direction.

8. The torque vectoring system of claim 6, further comprising:
a first thrust plate configured to transmit force from the lever arm onto the first clutch pack.

9. The torque vectoring system of claim 8, further comprising:
a second thrust plate configured to transmit force from the lever arm onto the second clutch pack.

10. The torque vectoring system of claim 7 wherein the lever arm is positioned between the first and second clutch packs such that the lever arm is precluded from moving concurrently in the first and second directions.

11. The torque vectoring system of claim 1, further comprising (i) a countershaft drive gear set having a countershaft gear meshed with a countershaft mating gear and (ii) a driven gear set having a first driven gear and a second driven gear, wherein the countershaft mating gear and the first driven gear are mounted for concurrent rotation with a gear shaft and the second driven gear is fixed for concurrent rotation with the other of the first and second drive axles.

12. The torque vectoring system of claim 1, further comprising:
an electromechanical clutch comprising:
a clutch pack having first and second sets of clutch plates;
a thrust plate moveably positioned proximate to the clutch pack; and
a ball screw assembly engaged with the thrust plate, the ball screw operable to move the thrust plate to press the first and second sets of clutch plates together and thereby lock the clutch.

13. The torque vectoring system of claim 12 wherein the thrust plate is further defined as pivotally moveable.

14. The torque vectoring system of claim 12 further comprising:
a thrust bearing positioned between the thrust plate and the first and second sets of clutch plates; and
a torsional spring engaged with a shaft of the ball screw assembly and operable to store energy when the shaft is being rotated by a motor of the ball screw assembly.

15. The torque vectoring system of claim 14 further comprising:
a lever mechanism positioned between the ball screw assembly and the thrust plate and wherein the ball screw assembly defines a modular packaging/layout and accommodates add-on design features.

16. The torque vectoring system of claim 14 further comprising:
a controller operable to control the motor, the controller storing in memory and operable to execute an actuator control algorithm reducing the likelihood of mechanical backlash and friction hysteresis.

17. A torque vectoring system comprising:
a differential;
a first drive axle operably coupled to the differential;
a second drive axle operably coupled to the differential;
a first gear train selectively driven by the differential and configured to selectively supply a speed application from the differential to one of the first and second drive axles;
a second gear train selectively driven by the differential and configured to selectively supply a speed reduction from the differential to one of the first and second drive axles;
a first clutch configured to selectively couple the first gear train to the first axle during a speed up request, the first clutch including a first clutch pack positioned in a first clutch basket;
a second clutch configured to selectively couple the second gear train to the first axle during a speed down request, the second clutch including a second clutch pack positioned in a second clutch basket; and
an actuator configured to selectively close one of the first clutch or the second clutch, wherein the actuator is configured to move a lever arm (i) in a first direction to close the first clutch and (ii) in a second direction to close the second clutch, the lever arm positioned between the first and second clutch packs such that the lever arm is precluded from moving concurrently in the first and second directions.

18. The torque vectoring system of claim 17, further comprising (i) a countershaft drive gear set having a countershaft gear meshed with a countershaft mating gear and (ii) a driven gear set having a first driven gear and a second driven gear, wherein the countershaft mating gear and the first driven gear are mounted for concurrent rotation with a gear shaft and the second driven gear is fixed for concurrent rotation with the other of the first and second drive axles.

19. The torque vectoring system of claim 17 wherein the actuator comprises a ball screw assembly including a motor that isolates a shaft in one of a first and second direction.

20. The torque vectoring system of claim 17, further comprising:
a first thrust plate configured to transmit force from the lever arm onto the first clutch pack; and
a second thrust plate configured to transmit force from the lever arm onto the second clutch pack.
